(19) United States
(12) Patent Application Publication
(10) Pub. No.: US 2003/0049384 A1
(43) Pub. Date: Mar. 13, 2003

(54) Process and apparatus for preparing transparent electrically conductive coatings

(76) Inventors: Jean H. Liu, Auburn, AL (US); Wen-Chiang Huang, Auburn, AL (US)

Correspondence Address: Wen-Chiang Huang, 2076 S. Evergreen Dr., Auburn, AL, 36830, US

(21) Appl. No.: 09/949,542

(22) Filed: Sep. 10, 2001

(51) Int. Cl. B05D 1/02

(52) U.S. Cl. 427/427; 427/446; 118/715

(57) ABSTRACT

A process and apparatus for producing a transparent, electrically conductive coating onto a substrate. The process includes: (a) operating heating and atomizing devices to provide a stream of super-heated fine-sized metal liquid droplets into a coating chamber in which the substrate is disposed; (b) introducing a stream of oxygen-containing gas into this chamber to impinge upon the stream of super-heated metal liquid droplets and exothermically react therewith to produce substantially nanometer-sized metal oxide clusters; and (c) directing the metal oxide clusters to deposit and form a coating onto the substrate.

The present invention results from a research sponsored by the SBIR Program of the U.S. National Science Foundation. The U.S. government has certain rights on this invention.

### FIELD OF THE INVENTION

The present invention relates to a process and associated apparatus for producing an optically transparent and electrically conductive substrate that is most suitable for use in liquid crystal displays (LCD), electrodes in solar batteries, anti-static shields, or electromagnetic wave shields, etc.

### BACKGROUND OF THE INVENTION

Transparent, electro-conductive substrates are obtained by two primary methods. The first method entails producing a thin film of an oxide, such as indium-tin oxide (hereinafter referred to as “ITO”) or antimony-tin oxide (“ATO”), on a glass or plastic substrate by sputtering or chemical vapor deposition (CVD). The second method involves coating a transparent, electro-conductive ink on a support such as a glass substrate. The ink composition contains a powder of ultra-fine, electro-conductive particles having a particle size smaller than the smallest wavelength of visible rays. The ink is then dried on the support, which is then baked at temperatures of 400° C. or higher.

The first method requires the utilization of expensive devices and its reproducibility and yield are low. Furthermore, the procedure is tedious and time-consuming, typically involving the preparation of fine oxide particles, compaction and sintering of these fine particles to form a target, and sputtering of this target in a high-vacuum environment. Therefore, it was difficult to obtain low-priced, transparent, electro-conductive coatings. The electro-conductive film formed on the support by the second method tends to have some gaps remaining between the ultra-fine particles thereon so that light scatters on the film, resulting in poor optical properties. In order to fill the gaps, heretofore, a process has been proposed in which a glass-forming component is incorporated into the transparent, electro-conductive ink prior to forming the transparent, electro-conductive substrate. However, the glass-forming component is problematic in that it exists between the ultra-fine, electro-conductive particles, thereby increasing the surface resistivity of the electro-conductive film to be formed on the support. For this reason, therefore, it was difficult to satisfy both the optical characteristics and the desired surface resistivity conditions of the transparent, electro-conductive substrate by the above-mentioned second method. In addition, the transparent, electro-conductive substrate formed by the second method has exhibited poor weatherability. When the substrate is allowed to stand in air, the resistance of the film coated thereon tends to increase with time.

The present invention has been made in consideration of these problems in the related prior arts, and its object is to provide a cost-effective method for directly forming a transparent, electro-conductive coating onto a glass or plastic substrate.

In order to produce a uniform, thin, and optically transparent oxide coating on a glass substrate, it is essential to produce depositable oxide species that are in the vapor or liquid state prior to striking the substrate. These oxide species are preferably individual oxide molecules or nanometer-sized clusters.

A relatively effective technique for producing fine metal clusters is atomization, which involves the breakup of a liquid into small droplets, usually in a high-speed jet. The major components of a typical atomization system include a melting chamber (including a crucible, a heating device, and a melt-guiding pipe) in a vacuum or protective gas atmosphere, an atomizing nozzle and chamber, and powder-drying (for water atomization) or cooling equipment (for gas atomization). The metal melt can be poured into first end of a guiding pipe having a second end with a discharging nozzle. The nozzle, normally located at the base of the pipe, controls the shape and size of the metal melt stream and directs it into an atomizing chamber in which the metal stream (normally a continuous stream) is disintegrated into fine droplets or clusters by the high-speed atomizing medium, either gas or water. Liquid droplets cool and solidify as they settle down to the bottom of the atomizing chamber. A subsequent collector system may be used to facilitate the separation (from the waste gas) and collection of powder particles. Powder producing processes using an atomizing nozzle are well known in the art: e.g., U.S. Pat. No. 5,125,574 (Jun. 30, 1992 to Anderson, et al.), U.S. Pat. No. 5,656,061 (Aug. 12, 1997 to Miller, et al.), U.S. Pat. No. 4,585,473 (Apr. 29, 1986 to Narasimhan, et al.), and U.S. Pat. No. 4,793,853 (Dec. 27, 1988 to Kale).

When a stream of metal melt is broken up into small droplets, the total surface energy of the melt increases. This is due to the fact that the creation of a droplet necessarily generates a new surface and every surface has an intrinsic surface tension or surface energy. When droplets are broken down into even smaller droplets, the total surface area of the droplets is further increased, given the same volume of material. This implies that a greater amount of energy must be consumed in creating this greater amount of surface area. Where does this energy come from? An atomizer works by transferring a portion of the kinetic energy of a high-speed atomizing medium to the fine liquid droplets. Because of the recognition that the kinetic energy (K.E.) of a medium with a mass m and velocity v is given by K.E.=½ m v², prior-art atomization technologies have emphasized the importance of raising the velocity of the atomizing medium when exiting an atomizing nozzle. In an industrial-scale atomizer jet nozzle, the maximum velocity of a jetting medium is limited, typically from 60 feet/sec to supersonic velocities. The latter high speeds can only be achieved with great difficulties, by using heavy and expensive specialty equipment. In most of the cases, low atomizing medium speeds led to excessively large powder particles (micron sizes or larger).

The effect of temperature on the surface tension of metal melt droplets has been largely overlooked in the prior-art atomization technologies. Hitherto, the metal melts to be atomized for the purpose of producing fine metal powders have been typically super-heated to a temperature higher than the corresponding melting point by an amount of 70 to 300° C. (135 to 572° F.); e.g., as indicated in U.S. Pat. No. 5,863,618 (Jan. 26, 1999) issued to Jarosinsky, et al. It is important to recognize that the higher the metal melt temperature the lower is its surface tension. A metal melt at a temperature near its vaporization point has a critically small surface tension (almost zero). This implies that a highly super-heated metal melt can be readily atomized to nanometer-scaled droplets without requiring a high atomizing medium speed. Prior-art technologies have not taken advantage of this important feature. In actuality, it is extremely difficult, if not impossible, for prior-art atomization techniques to make use of this feature for several reasons. Firstly, the vaporization temperature of a metal is typically higher than its melting temperature by one to three thousands of degrees K. The metal melt has to be super-heated to an extremely high temperature to reach a state of very low surface tension. In a traditional atomization apparatus, it is difficult to heat a bulk quantity of metal in a crucible above a temperature higher than 3,500° C. (3,773° K), even with induction heating. Second, in a traditional atomization apparatus, the metal melt must be maintained at such a high temperature for an extended period of time prior to being introduced into an atomizer chamber. This requirement presents a great challenge as far as protection of the metal melt against oxidation (prior to atomization) is concerned since oxidation rate is extremely high at such an elevated temperature. Third, such a high-temperature metal melt would have a great tendency to create severe erosion to the wall of the melt-guiding pipe through which the melt is introduced into an atomizer chamber. Very few materials, if any, will be able to withstand a temperature higher than 5,500° C., for example, to be selected as a guiding pipe for refractory metal melt such as tungsten and tantalum. Fourth, the operations of pouring and replenishing a crucible with metal melt implies that the traditional atomization can only be a batch process, not a continuous process and, hence, with a limited production rate.

Further, melt atomization has been employed to produce ultra fine metallic powders, but rarely for producing ceramic powders directly. This is largely due to the fact that ceramic materials such as oxides and carbides have much higher melting temperatures as compared to their metal counterparts and require ultra-high temperature melting facilities. Therefore, ultra fine ceramic particles are usually produced by firstly preparing ultra fine base metal particles, which are then converted to the desired ceramics by a subsequent step of oxidation, carbonization, and nitride formation, etc.

Instead of allowing the ultra-fine liquid clusters in the liquid or vapor state after atomization to cool and solidify to become separate powder particles, one may direct these clusters to impinge upon a substrate, permitting these clusters to become solidified thereon to form a thin metal coating layer. However, we have further discovered that, by introducing an oxygen-containing gas into the chamber to react with the super-heated liquid metal droplets or clusters, one can readily convert these metal clusters into nanometer-sized oxide clusters. The heat generated by the exothermic oxidation reaction can in turn accelerate the oxidation process and, therefore, make the process self-sustaining or self-propagating. The great amount of heat released can also help to maintain the resulting oxide clusters in the liquid state or even turn them into the vapor state. Rather than cooling and collecting these clusters to form individual powder particles, these nanometer-sized liquid or vapor clusters can be directed to form an ultra-thin oxide coating onto a glass or plastic substrate. Selected oxide coatings such as, zinc oxide, ITO and ATO, are optically transparent and electrically conductive.

### SUMMARY OF THE INVENTION

A preferred embodiment of the present invention is a process for producing an optically transparent and electrically conductive coating onto a substrate. The process includes three primary steps: (a) operating heating and atomizing devices to provide a stream of super-heated fine-sized metal liquid droplets into a deposition chamber in which the substrate is disposed; (b) introducing a stream of oxygen-containing gas into this chamber to impinge upon the stream of super-heated metal liquid droplets and exothermically react therewith to produce substantially nanometer-sized metal oxide clusters; and (c) directing these metal oxide clusters to deposit onto the substrate for forming the desired coating.

In the first step, the process begins with super-heating a molten metal (either a pure metal or metal alloy) to an ultra-high temperature (e.g., higher than its melting point by 1,000 to 3,000° K) and breaking up (atomizing) the melt into fine liquid droplets in the deposition chamber. An oxygen-containing gas is introduced into the chamber to react with the super-heated liquid droplets to form metal oxide clusters. In this case, the oxygen-containing gas only serves to provide the needed oxygen for initiating and propagating the exothermic oxidation reaction to form the oxide clusters in the liquid or vapor state, which are then deposited onto the substrate to form a thin coating. In one further preferred embodiment, however, the oxygen-containing gas can also function as an atomizing medium. Still further preferably, a vortex jet nozzle may be used to receive a pressurized atomizing gas that contains oxygen from a source (e.g., a compressed gas cylinder) and discharges the gas through an outlet (an orifice or a multiplicity of orifices) into the deposition chamber. This outlet is preferably annular in shape and engulfing the perimeter of the stream of super-heated metal melt droplets, i.e., coaxial with the droplet stream. When the stream of metal melt droplets are supplied into the chamber, the pressurized gas medium, also referred to as the atomizing medium, is introduced through the jet nozzle to impinge upon the stream of super-heated metal droplets to further atomize the metal melt droplets into nanometer sizes. Alternatively, this oxygen-containing gas can act as the only atomizing medium to break up an otherwise continuous stream of super-heated metal melt. The oxygen molecules in this case would also react with the resulting liquid droplets to form oxide clusters.

The heating and atomizing devices preferably include a thermal spray device selected from the group consisting of an arc spray device, a plasma spray device, a gas combustion spray device, an induction heating spray device, a laser-assisted spray device, and combinations thereof. Further preferably, the thermal spray device is a twin-wire arc spray device. The twin-wire arc spray process, originally designed for the purpose of spray coating, can be adapted for providing a continuous stream of super-heated metal melt droplets. This is a low-cost process that is capable of readily heating up the metal wire to a temperature as high as 6,000° C. A pressurized carrier gas is introduced to break up the metal melt into fine droplets, typically 5-200 μm in diameter. In an electric arc, the metal is rapidly heated to an ultra-high temperature and is broken up essentially instantaneously. Since the wires can be continuously fed into the arc-forming zone, the arc spray is a continuous process, which means a high coating rate.

During the first step, the super-heated metal liquid droplets are preferably heated to a temperature at least two times the melting point of the metal when expressed in terms of degrees Kelvin. Further preferably, the super-heated metal liquid droplets are at a temperature that lies between two times and 3.5 times the melting point of the metal when expressed in terms of degrees Kelvin. This could mean a temperature as high as 6,000° C. to ensure that the metal melt has a very small or approximately zero surface tension. This is readily achieved by using a thermal spray nozzle in the practice of the present invention. In contrast, in a prior-art atomizer system, it is difficult to use a furnace or induction generator to heat a crucible of metal to a temperature higher than 2,500° C.

The presently invented process is applicable to essentially all metallic materials, including pure metals and metal alloys. When high service temperatures are not required, the metal may be selected from the low melting point group consisting of antimony, bismuth, cadmium, cesium, gallium, indium, lead, lithium, rubidium, selenium, tellurium, tin, and zinc. When a high service temperature is required, a metallic element may be selected from the high-melting refractory group consisting of tungsten, molybdenum, tantalum, hafnium and niobium. Other metals with intermediate melting points such as copper, zinc, aluminum, iron, nickel and cobalt may also be selected. Indium, tin, zinc, and antimony are currently the preferred choices of metal for practicing the present invention.

In the second step, oxygen molecules are introduced to react with the liquid droplets and, preferably, to further break up the liquid droplets. Preferably, the jet nozzle in a gas atomization device is a vortex jet nozzle for a more efficient atomization action. Preferably the atomizing fluid medium includes oxygen and a gas selected from the group consisting of argon, helium, hydrogen, carbon, nitrogen, chlorine, fluorine, boron, sulfur, and combinations thereof. Argon and helium are noble gases and can be used as a purely atomizing gas (without involving any chemical reaction) or as a means to regulate the oxidation rate. The other gases may be used to react with the metal melt to form ceramic phases of hydride, oxide, carbide, nitride, chloride, fluoride, boride, and sulfide, respectively, in the resulting coating if so desired.

Specifically, if the atomizing gas medium contains a reactive gas (e.g., oxygen), this reactive gas will also rapidly react with the super-heated metal melt (in the form of fine droplets) to form nanometer-sized ceramic clusters (e.g., oxides). If the atomizing gas contains a mixture of two or more reactive gases (e.g., oxygen and nitrogen), the resulting product will contain a mixture of oxide and nitride clusters. If the metal melt is a metal alloy or mixture (e.g., containing both indium and tin elements) and the reactive gas is oxygen, the resulting product will contain ultra-fine indium-tin oxide clusters that can be directed to deposit onto a substrate.

At the ultra-high temperature (1,000 to 3,000° K above the metal melting point or 2.0 to 3.5 times of the melting point using absolute Kelvin scale), the surface tension of the metal melt is negligibly small and the liquid stream can be readily broken up into ultra-fine droplets. At such a high temperature, metal melt is normally capable of initiating a substantially spontaneous reaction with a reactant species (e.g., oxygen) contained in the atomizing gas medium. In this case, the pressurized gas not only possesses a sufficient kinetic energy to break up the metal melt stream into finely divided droplets, but also contains active reactant species to undergo a reaction with these fine metal droplets at high temperatures in a substantially spontaneous and self-sustaining fashion. The reaction heat released is effectively used to sustain the reactions in an already high temperature environment.

Still another preferred embodiment is an apparatus for producing an optically transparent, electrically conductive coating onto a substrate. The apparatus includes (a) a coating chamber to accommodate the substrate, (b) heating and atomizing means in supplying relation to the coating chamber, including heating devices for melting a metal and super-heating the metal melt to a temperature at least 500 (preferably 1000) degrees Kelvin above the melting point of the metal and atomizing means for breaking up the super-heated metal melt into fine liquid droplets which travel inside the chamber; (c) gas supply means disposed a distance from the deposition chamber for supplying an oxygen-containing gas into the chamber for reacting with the liquid metal droplets therein to form substantially nanometer-sized metal oxide clusters; and (d) supporting-conveying means to support and position the substrate into the chamber, permitting the metal oxide clusters to deposit and form a coating onto the substrate. Preferably, the supporting-conveying means are made to be capable of transferring, intermittently or continuously, a train of substrate glass pieces into the deposition chamber for receiving the depositable oxide clusters and then transferring them out of the chamber once a coating of a desired thickness is deposited on the substrate.

Advantages of the present invention may be summarized as follows:

1. A wide variety of metallic elements can be readily converted into nanometer-scaled oxide clusters for deposition onto a glass or plastic substrate. The starting metal materials can be selected from any element in the periodic table that is considered to be metallic. In addition to oxygen, partner gas species may be selected from the group consisting of hydrogen, carbon, nitrogen, chlorine, fluorine, boron, and sulfur to help regulate the oxidation rate and, if so desired, form respectively metal hydrides, oxides, carbides, nitrides, chlorides, fluorides, borides, and sulfides and combinations thereof. No known prior-art technique is so versatile in terms of readily producing so many different types of ceramic coatings on a substrate.

2. The presently invented process makes use of the concept that a metal melt, when super-heated to an ultra-high temperature (e.g., reaching 2 to 3.5 times its melting temperature in degrees K) has a negligibly small surface tension so that a melt stream can be easily broken up into nano-scaled clusters without involving expensive or heavy atomizing nozzle equipment that is required to create an ultra-high medium speed. Prior-art atomization apparatus featuring a crucible for pouring metal melt into a melt-guiding pipe are not capable of reaching such a high super-heat temperature and/or making use of this low surface tension feature due to the four major reasons discussed earlier in the BACKGROUND section.

3. The metal melt can be an alloy of two or more elements which are uniformly dispersed. When broken up into nano-sized clusters, these elements remain uniformly dispersed and are capable of reacting with oxygen to form uniformly mixed ceramic coating, such as indium-tin oxide. No post-fabrication mixing is necessary.

4. The near-zero surface tension also makes it possible to generate metal clusters of relatively uniform sizes, resulting in the formation of relatively uniform ceramic coatings.

5. The selected super-heat temperatures also fall into the range of temperatures within which a spontaneous reaction between a metallic element and a reactant gas such as oxygen can occur. The reaction heat released is automatically used to maintain the reacting medium in a sufficiently high temperature so that the reaction can be self-sustaining until completion. The reaction between a metal and oxygen can rapidly produce a great amount of heat energy, which can be used to maintain the oxide clusters in the liquid or vapor state.

6. The process involves the integration of super-heating, atomizing, and reacting steps into one single operation. This feature, in conjunction with the readily achieved super-heat conditions, makes the process fast and effective and now makes it possible to mass produce transparent and conductive coatings on a substrate cost-effectively.

7. The apparatus needed to carry out the invented process is simple and easy to operate. It does not require the utilization of heavy and expensive equipment such as a laser or vacuum-sputtering unit. It is difficult for a process that involves a high vacuum to be a continuous process. The over-all product costs produced by the presently invented vacuum-free process are very low.

### BRIEF DESCRIPTION OF THE DRAWINGS

FIG. 1 shows the schematic of a preferred embodiment of an apparatus for producing oxide coating on a substrate.

FIG. 2 schematically shows the working principle of an electric arc spray-based device for generating a stream of highly super-heated fine metal liquid droplets (two examples of the first-step heating and atomizing means): (a) an open-style arc-spray nozzle and (b) a closed-style arc-spray nozzle in which the arc zone is enclosed by an air cap 76.

FIG. 3 a plasma spray nozzle as another example of the heating and atomizing means.

### DETAILED DESCRIPTION OF PREFERRED EMBODIMENTS

A. Apparatus

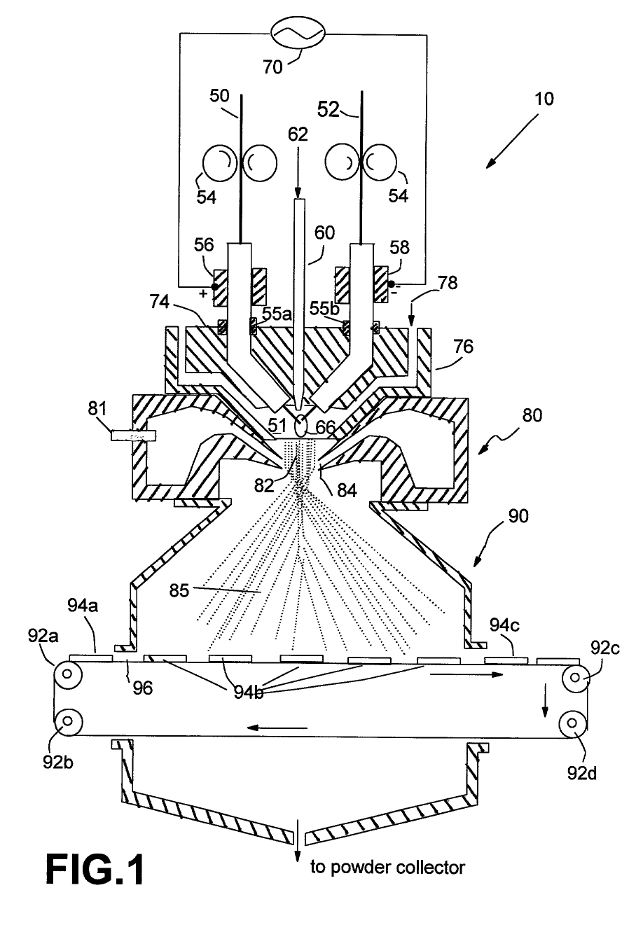

FIG. 1 schematically shows a coating apparatus, in accordance with a preferred embodiment of the present invention, for producing an optically clear and electrically conductive coating on a glass or plastic substrate. This apparatus includes four major functional components: (1) a coating chamber 90, (2) heating and atomizing means 10, (3) gas-supplier (not shown; supplying atomizing-reactive gases through pipe means 60, and/or passages 78, 84, and (4) substrate supporter-conveyor (e.g., conveying rollers 92a, 92b, 92c, 92d and belt 96).

In the heating and atomizing means 10, there provided heating means for melting a metallic material (normally supplied in a wire or rod form) and for super-heating the metal melt to a temperature normally at least 1000 degrees Kelvin above the melting point of the metal. Also provided is an atomizing means for breaking up the super-heated metal melt into fine liquid droplets (smaller than 200 μm, but preferably smaller than 20 μm in diameter). In a preferred embodiment of the presently invented apparatus, as indicated in FIG. 1, the heating and atomizing means includes a twin-wire electric arc spray nozzle, which is mainly composed of an electrically insulating block 74, two feed wires 50, 52, an atomizing gas passage means 60, and a secondary atomizing gas nozzle with a gas passage 78. The two metal wires 50, 52 are supplied with a DC voltage (one “+” and the other “−”) or a pulsed power 70 to form an arc 66 in an arc chamber 51. This arc 66, being at an ultra-high temperature (up to 6,000° C.), functions to melt the wire tips and super-heat the resulting metal melt. A stream of atomizing/carrier gas from a source 62 (not shown; denoted by an arrow) passes through the passage means 60 into the arc chamber 51 to atomize the metal melt (breaking up the melt into fine liquid droplets) and to carry the stream of metal liquid droplets downward toward the coating chamber 90.

The two wires 50, 52 can be fed through air-tight means 55a, 55b into the arc chamber 51, continuously or intermittently on demand, by a wire-feeding device (e.g., powered rollers 54). An optional secondary atomizing gas nozzle (having a gas passage 78) can be used to further break up the metal melt droplets, providing a stream of super-heated fine metal melt droplets into the coating chamber 90. The atomizing devices (including 60 and 78) are operated in such a fashion that they provide a stream of liquid droplets that are as highly super-heated and as finely divided as possible. However, the speed of the atomizing gas (from either 60 or 78) cannot be too high due to the fact that the gas comes in direct contact with the arc 66. Too high a gas speed in the arc chamber 51 could adversely affect the quality of the arc, e.g., may tend to diminish or extinct the arc. This is one of the reasons why a two-stage atomizing device is preferred over a single stage one.

The second-stage atomizing means is positioned a distance from the first-stage atomizing means for receiving the super-heated metal liquid droplets 82 therefrom. The second-stage atomizing means includes a supply of a pressurized gas medium (e.g., a compressed oxygen-containing gas bottle, not shown) disposed a distance from the chamber and a jet nozzle 80 in flow communication with both the coating chamber 90 and the pressurized fluid gas supply. The jet nozzle 80 comprises on one side an in-let pipe (not shown) for receiving the gas from the supply and on another side a discharge orifice 84 (an outlet that is either a single orifice of a predetermined size and shape or a multiplicity of orifices) through which the pressurized gas medium is dispensed into the coating chamber 90 to impinge upon the super-heated metal liquid droplets 82 for further breaking these liquid droplets down to being nanometer-sized. The atomizing jet is preferably a more effective vortex jet nozzle. Although preferably so, the oxygen-containing gas thus supplied does not have to act as an atomizing gas medium. The primary purpose of this gas is to initiate and sustain an exothermic oxidation reaction to convert the fine metal droplets into depositable metal oxide clusters that are in the liquid or vapor state.

The ultra-fine oxide clusters 85 are then directed to deposit onto a glass or plastic substrate (e.g., 94b) being supported by a conveyor belt 96 which is driven by 4 conveyor rollers 92a-92d. The lower portion of FIG. 1 shows a train of substrate glass pieces, including 94a (un-coated), 94b (being coated) and 94c (coated). The oxide clusters that are not deposited will be cooled to solidify and become solid powder particles. These powder particles, along with the residual atomizing gases and cooling gas, are transferred through a conduit to an optional powder collector/separator system (not shown).

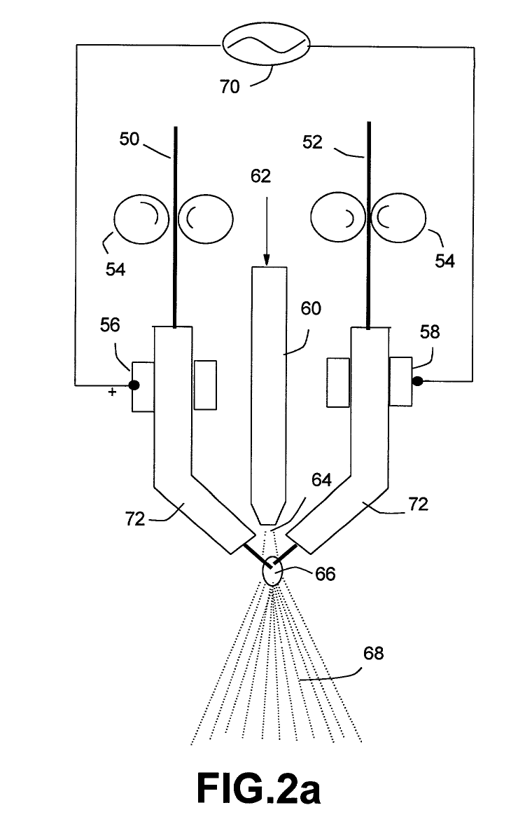

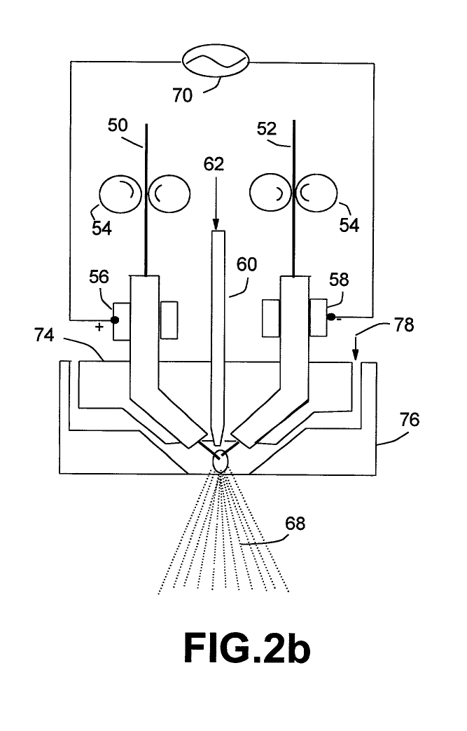

The twin-wire arc spray nozzle is but one of the many devices that can be used as the heating and atomizing means. Other types of thermal spray devices that can be used in the practice of the present invention include a plasma spray device, a gas combustion spray device, an induction heating spray device, a laser-assisted spray device, and combinations thereof. An electric arc spray nozzle, particularly a twin-wire arc spray nozzle, is a preferred choice, however. The twin-wire arc spray nozzle, originally developed for use in a spray coating process, can be adapted for providing a continuous stream of super-heated metal melt droplets. This low-cost process is capable of readily heating up the metal wire to a temperature as high as 6,000° C. and is further illustrated in FIGS. 2a and 2b.

Schematically shown in FIG. 2a is an open-style twin-wire arc spray nozzle. Two metal wires 50, 52 are driven by powered rollers 54 to come in physical contact with two respective conductive jackets 72 which are supplied with “+” and “−” voltage or pulsed power through electrically conductive blocks 56 and 58, respectively. The voltage polarity may be reversed; i.e., “−” and “+” instead of “+” and “−”. The voltages come from a DC or pulsed power source 70. The lower ends of the two wires approach each other at an angle of approximately 30-60°. The two ends are brought to contact each other for a very brief period of time. Such a “short circuit” contact creates an ultra-high temperature due to a high current density, leading to the formation of an arc 66. A stable arc can be maintained provided that the voltage is constantly supplied, a certain level of gas pressure is maintained, and the wires are fed at a constant or pulsating speed. A stream 64 of compressed air, introduced through a gas passage 60 from a gas source (e.g., compressed air bottle, not shown), serves to break up the melt produced inside the arc zone 66 to become finely divided metal melt droplets 68, which remain highly super-heated (i.e., at a temperature much higher than the melting point of the metal, typically by at least 1,000° in Kelvin scale).

The metal melt droplets produced by the above-described open-style twin-wire arc spray nozzle tend to be high in diameter (typically 100-200 μm). An improved version is a closed-style arc spray nozzle as schematically shown in FIG. 2b. In this spray arc nozzle, the arc zone is enclosed by an air cap 76 and additional compressed gas or air (referred to as the secondary atomizing gas) is introduced (e.g., from 78) into the arc zone to compress the arc. The increased arc zone pressure effectively increases the atomizing speed and the arc temperature, thereby promoting the more efficient atomization resulting in much finer liquid droplets (typically less than 50 μm and often less than 10 μm in diameter). These super-heated fine liquid droplets (e.g., 68) are then carried into the coating chamber for further size reduction and/or oxidation reaction.

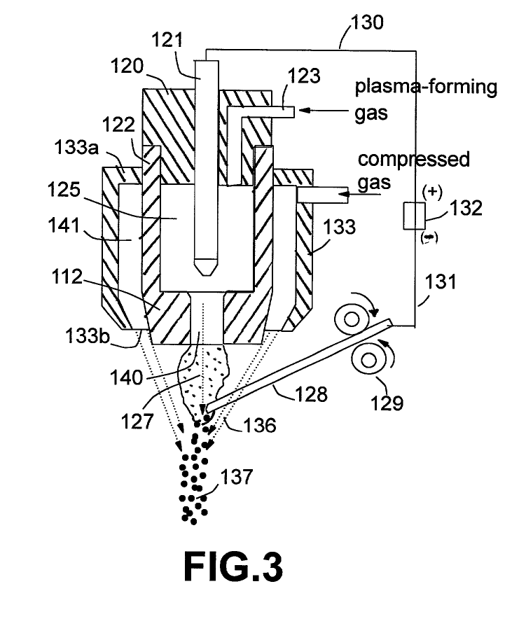

Other types of thermal spray devices that can be used in the present invention include a plasma arc spray nozzle. FIG. 3 shows an example of a plasma spray nozzle that involves feeding a wire 128 of metal (or metal powders) into the transferred arc 127 which rapidly fuses the metal for atomization. A secondary flow of compressed air functions to atomize the molten metal into fine super-heated droplets. This plasma arc spray nozzle is composed of the following major elements: An electrode 121 is mounted coaxially within an electrically insulating block 120 at one end of a cylindrical metal body 122, the opposite end of the body 122 is closed off by an end wall 112, provided with an axial bore forming a nozzle orifice 140. The electrode 121 is coaxial with the nozzle passage or bore, and within an annular chamber 125. A plasma-forming gas is introduced through a tube 123 to chamber 125, where the plasma-forming gas passes into and through the nozzle orifice 140. Concentrically surrounding the body 122 is a cup-shaped member 133, forming an annular space 141 between the cup-shaped member 133 and the cylindrical body 122. One end of the cup-shaped body 133 is closed off by end wall 133a, while its opposite end 133b is open. Compressed air is introduced through a tube into the annular space 141 for discharge through the open end of the cup-shaped member 133 to form a high-speed air flow 136, which functions to atomize the metal fed into the plasma arc (arc column being indicated by 127). The wire 128 is fed into the developed arc 127 by powered rollers 129 which rotate in the direction of the arrows to feed the wire. An electric potential difference is developed between the wire 128, a cathode, and the electrode 121, an anode, from a DC electric source 132 via leads 130, 131 coupled respectively to the anode 121 and the cathode wire 128. The ultra-high temperature in the plasma arc (typically between 2,000° K and as high as 32,000° K) rapidly melts out and highly super-heat the metal, which is instantaneously atomized by the air flow 136.

In FIG. 1, the second-stage atomizer device is for receiving a super-heated stream of metal melt droplets 82 from the up-stream heating and atomizing means discussed earlier. This second-stage atomizer device comprises a jet nozzle 80 having on one side an inlet pipe means 81 for receiving the atomizing gas from an oxygen gas source and on another side a discharge orifice 84 of a predetermined size and shape through which the atomizing gas is dispensed to impinge upon the stream of super-heated metal melt droplets 82. Preferably, as shown in FIG. 1, the nozzle discharge orifice 84 is annular in shape and coaxial with the stream of metal melt droplets 82. The orifice outlet 84 is oriented in such a fashion that the pressurized oxygen-containing gas, immediately upon discharge from the orifice, impinges upon the super-heated metal melt stream. It may be noted that, if the atomizing gas coming out of the orifice 84 contains a reactive gas such as oxygen, the highly super-heated metal droplets can quickly react with oxygen to form oxide particles. Since the oxidation of a metal is normally a highly exothermic process, a great amount of reaction heat is released which can in turn be used to activate, maintain, or accelerate the oxidation reactions of other metal droplets. Such a self-sustaining reaction rapidly converts the liquid droplets into ceramic clusters.

As a preferred embodiment, the jet nozzle may be a vortex-loop-slot jet nozzle for a more efficient atomization action. A pressurized gas may be introduced from a compressed air source through one or more inlet pipes into a vortex chamber in which the gas molecules swirl around several circles before finally entering the annular slit leading to the orifice 84. This configuration allows the pressurized gas (the atomizing medium) to effectively transfer the kinetic energy of the high speed fluid molecules to the stream of liquid metal droplets 82. A variety of atomizing nozzle configurations are available in the prior art.

B. Process

Another preferred embodiment of the present invention involves a process for producing transparent, electrically conductive coating on a substrate. Although parts or all of this process have been discussed in earlier sections, the most essential elements of this invented process will be recapitulated as follows:

In the first step, again referring to FIG. 1, the process begins with super-heating a molten metal (either a pure metal or metal alloy, preferably in a wire or powder form) to an ultra-high temperature (e.g., higher than its melting point by preferably at least 1,000 to 3,000° K) and breaking up (atomizing) the melt into fine liquid droplets. This stream of highly super-heated metal melt droplets, remaining at an ultra-high temperature even after the atomization, is then introduced into a coating chamber for oxidation and possibly additional size reduction to become depositable metal oxide clusters that are essentially nanometer-sized.

When the stream of metal melt droplets are supplied into the coating chamber, the pressurized gas medium is introduced through the jet nozzle to impinge upon the stream of super-heated metal droplets to further atomize the melt droplets into nanometer sizes. The jet nozzle (e.g., 84 in FIG. 1) of this second-stage atomizer is oriented in such a fashion that the atomizing gas will not come in direct contact with the arc. In such a configuration, the speed of the atomizing fluid medium would not be constrained by the risk of diminishing the arc and, therefore, can be much higher than the speed of the first-stage atomizing gas. This leads to a much more effective atomization. Further, if the second-stage atomizing gas contains a highly reactive gas such as oxygen (as is the case here) for the purpose of producing ceramic clusters, this atomizing gas would not adversely affect the quality of the arc. This presents another advantage of a two-stage atomizing process over a single-stage one.

During the first step of the presently invented process, the super-heated metal liquid droplets are preferably heated to a temperature at least 2 times the melting point of the metal when expressed in terms of degrees Kelvin. Further preferably, the super-heated metal liquid droplets are at a temperature that lies between 2 times and 3.5 times the melting point of the metal when expressed in terms of degrees Kelvin. This would bring the liquid melt to a state of negligible surface tension. These can be readily achieved by using a twin-wire arc or plasma spray unit. If oxidation or other types of reactions (e.g., carbonization, nitride formation, etc.) are desired for the purpose of producing ceramic clusters, these reactions can be deferred until the super-heated metal liquid droplets are carried into the second-stage atomizer chamber in which the atomizing gas contains reactive species such as oxygen, carbon, nitrogen, chlorine, etc.

It may be noted that the presently invented process is applicable to essentially all metallic materials, including pure metals and metal alloys. When high service temperatures are not required, the metal may be selected from the low melting point group consisting of antimony, bismuth, cadmium, cesium, gallium, indium, lead, lithium, rubidium, selenium, tellurium, tin, and zinc. Table 1 shows the desired processing temperatures of these metallic elements.

TABLE 1
The melting point and super-heat temperature
of selected low-melting metals.

| Metal | Melting Point (° K) | Super-Heat Temperature (° K) |
|---|---|---|
| Bismuth (Bi) | 544.4 | 1,280 |
| Cadmium (Cd) | 594 | 1,485 |
| Cesium (Cs) | 301.6 | 760 |
| Gallium (Ga) | 302.8 | 780 |
| Indium (In) | 429.6 | 1,480 |
| Lead (Pb) | 600.4 | 1,500 |
| Lithium (Li) | 453.7 | 1,140 |
| Rubidium (Rb) | 311.9 | 780 |
| Selenium (Se) | 490 | 1,225 |
| Tellurium (Te) | 722.5 | 1,806 |
| Tin (Sn) | 504.9 | 1,425 |
| Zinc (Zn) | 693 | 1,735 |

When a high service temperature is required, a metallic element may be selected from the high-melting refractory group consisting of tungsten, molybdenum, tantalum, hafnium and niobium. The liquid metal temperature is preferably at 4,000-6,500° C. for these refractory metals. Other metals with intermediate melting points such as copper, zinc, aluminum, iron, nickel and cobalt may also be selected, with metal melt temperature in the range of 3,000-5,000° C. For the flat-panel display applications, indium-tin, zinc, and antimony are the preferred metals for use in the present process. These materials have been found to produce good-quality transparent, electrically conductive oxide coatings on a glass or plastic substrate.

If the atomizing gas medium contains a reactive gas (e.g., oxygen), this reactive gas will also rapidly react with the super-heated metal melt (in the form of fine droplets) to form nanometer-sized ceramic clusters (e.g., oxides). If the atomizing gas contains a mixture of two or more reactive gases (e.g., oxygen and nitrogen), the resulting product will contain a mixture of oxide and nitride). If the metal melt is a metal alloy or mixture (e.g., containing both indium and tin elements) and the reactive gas is oxygen, the resulting product will contain ultra-fine indium-tin oxide particles. This implies that the presently invented process is capable of producing single-component or multi-component ceramic coatings.

At the ultra-high temperature (1,000 to 3,000° K above the metal melting point or 2.0 to 3.5 times of the melting point using absolute Kelvin scale), the surface tension of the metal melt is negligibly small and the liquid stream can be readily broken up into ultra-fine droplets. The breakup of a stream of liquid with an ultra-low surface tension can be easily achieved. As a matter of fact, it does not require any specialized, powerful atomizer. The present process, therefore, can be readily accomplished without necessarily involving expensive or heavy atomizing nozzle equipment designed for achieving an ultra-high medium speed. The near-zero surface tension also makes it possible to generate metal clusters of relatively uniform sizes, resulting in the formation of high-quality ceramic coatings. Furthermore, at such a high temperature, metal melt is normally capable of initiating a substantially spontaneous reaction with a reactant species (e.g., oxygen) contained in the atomizing medium of the second-stage atomizer device. In this case, the pressurized gas not only possesses a sufficient kinetic energy to break up the metal melt stream into finely divided droplets, but also contains active reactant species to undergo a reaction with these fine metal droplets at high temperatures in a substantially spontaneous and self-sustaining fashion. The reaction heat released is effectively used to sustain the reactions in an already high temperature environment.

If the production of a uniform mixture of ceramic coating from a metallic alloy is desired, this alloy can be introduced as two wires of identical composition into the twin-wire arc spray nozzle, as shown in FIG. 1a, 2a, or 2b. Alternatively, the two wires may be made up of different metal compositions. For example, a technologically important oxide mixture is indium-tin oxides. This product can be used in a flat panel display technology. In one instance, a tin wire and an indium wire were fed into an arc sprayer nozzle and super-heated to approximately 1,300° C. for two-stage atomization. In the second-stage atomization chamber, an oxygen flow at a rate of 200 scfm under a gas pressure of approximately 200 psi was used to atomize and react with the metal melt mixture. Ultra-fine indium-tin oxide clusters with an average diameter of 50 nm were obtained. The resulting coatings were smooth and uniform.

What is claimed:

1. A process for producing a transparent electrically conductive coating onto an optically transparent substrate, said process comprising:
(a) operating heating and atomizing means to provide a stream of super-heated fine metal liquid droplets into a chamber in which said substrate is disposed;
(b) introducing a stream of oxygen-containing gas into said chamber to impinge upon said stream of super-heated metal liquid droplets and exothermically react therewith to produce substantially nanometer-sized metal oxide clusters; and
(c) directing said metal oxide clusters to deposit onto said substrate for forming said coating.

2. The process as set forth in claim 1, wherein said heating and atomizing means comprising a thermal spray device selected from the group consisting of an arc spray device, a plasma spray device, a gas combustion spray device, an induction heating spray device, a laser-assisted spray device, and combinations thereof.

3. The process as set forth in claim 2, wherein said thermal spray device comprising a twin-wire arc spray device.

4. The process as set forth in claim 1, wherein said super-heated metal liquid droplets are at a temperature at least two times the melting point of said metal when expressed in terms of degrees Kelvin.

5. The process as set forth in claim 1, wherein said super-heated metal liquid droplets are at a temperature at least 3.5 times the melting point of said metal when expressed in terms of degrees Kelvin.

6. The process as set forth in claim 1, wherein said metal liquid droplets comprising at least one metallic element selected from the low melting point group consisting of bismuth, cadmium, antimony, cesium, gallium, indium, lead, lithium, rubidium, selenium, tellurium, tin, and zinc.

7. The process as set forth in claim 1, wherein said fine metal liquid droplets comprising indium and tin elements.

8. The process as set forth in claim 1, wherein said stream of oxygen-containing gas further comprising a gas selected from the group consisting of argon, helium, hydrogen, carbon, nitrogen, chlorine, fluorine, boron, sulfur, and combinations thereof.

9. The process as set forth in claim 1, wherein said transparent substrate comprising a train of individual pieces of glass or plastic being moved sequentially or concurrently into said chamber and then moved out of said chamber after said coating is formed.

10. The process as set forth in claim 1, wherein said metal comprising an alloy of at least two metallic elements.

11. The process as set forth in claim 1, wherein said stream of oxygen-containing gas reacting with said super-heated metal liquid droplets in such a manner that the reaction heat released is used to sustain said reaction until most of said metal droplets are substantially converted to nanometer-sized ceramic clusters.

12. The process as set forth in claim 1, wherein said stream of oxygen-containing gas being pre-heated to a predetermined temperature prior to being introduced to impinge upon said metal liquid droplets.

13. An apparatus for producing a transparent electrically conductive coating onto a substrate, said apparatus comprising
(a) a coating chamber,
(b) heating and atomizing means in supplying relation to said coating chamber, comprising heating means for melting a metal and super-heating said metal melt to a temperature at least 1,000 degrees Kelvin above the melting point of said metal;
atomizing means in atomizing relation to said metal melt for breaking up said super-heated metal melt into fine liquid droplets which travel inside said chamber;
(c) gas supply means disposed a distance from said chamber for supplying an oxygen-containing gas into said chamber to react with said liquid metal droplets therein for forming substantially nanometer-sized metal oxide clusters; and
(d) supporting-conveying means to support and position said substrate into said chamber, permitting said metal oxide clusters to deposit and form a coating onto said substrate.

14. The apparatus of claim 13, wherein said gas supply means comprising a jet nozzle in flow communication with a gas source and said coating chamber; said nozzle comprising on one side in-let pipe means for receiving said oxygen-containing gas from said source and on another side a discharge orifice of a predetermined size and shape or a multiplicity of orifices through which said gas is dispensed into said chamber to impinge upon said super-heated metal liquid droplets for reacting with said droplets to form said oxide clusters.

15. The apparatus as set forth in claim 14, wherein said jet nozzle comprising a vortex jet nozzle.

16. The apparatus as set forth in claim 13, wherein said heating and atomizing means comprising a thermal spray device selected from the group consisting of an arc spray device, a plasma spray device, a gas combustion spray device, an induction heating spray device, a laser-assisted spray device, and combinations thereof.

17. The apparatus as set forth in claim 16, wherein said thermal spray device comprising a twin-wire arc spray device.
